(19) United States
(12) Patent Application Publication
(10) Pub. No.: US 2003/0167222 A1
(43) Pub. Date: Sep. 4, 2003

(54) Method and apparatus for marketing within a complex product space

(76) Inventors: Sunil Mehrotra, Westlake Village, CA (US); Mark Fasciano, Mineola, NY (US); Marc Trudeau, Endicott, NY (US)

Correspondence Address: Mr. Sunil Mehrotra, 370 N. Westlake Blvd, Westlake Village, CA, 91362, US

(21) Appl. No.: 09/753,985

(22) Filed: Jan. 2, 2001

Related U.S. Application Data
(60) Provisional application No. 60/203,518, filed on May 8, 2000.
(60) Provisional application No. 60/217,618, filed on Jul. 11, 2000.

(51) Int. Cl. G06F 17/60

(52) U.S. Cl. 705/37

(57) ABSTRACT

A system for marketing within a complex product space. The system allows a portal merchandiser to support suppliers, dealers, and customers within a speciality dealership network created to distribute complex consumer products. The system comprises a central merchandising portal website deployed on the Internet connected to a plurality of dealership point of sale and inventory systems and a plurality of supplier inventory systems. A customer accessing the site is presented with a virtual inventory database with product availability and pricing established by merchandising rules set by the merchandising portal, the suppliers, and the dealer closest in physical proximity to the customer as determined by the customer's zip code. The customer is given extensive customer support throughout a “Learn Build Buy Support” process by having access to expert systems and live experts through the merchandising portal.

### CROSS-REFERENCE TO RELATED APPLICATION

This application claims the benefit of U.S. Provisional Applications No. 60/203,518 filed May 8, 2000, and No. 60/217,618 filed Jul. 11, 2000 which are hereby incorporated by reference as if set forth in full herein.

### BACKGROUND OF THE INVENTION

The present specification includes a CD-ROM containing computer source code which is referred to in the specification as the Appendix.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

This invention relates generally to the field of electronic commerce over the Internet and specifically to marketing products that meet complex customer requirements.

The rapid adoption of the Internet as the mass marketing medium of choice for consumer products has been beneficial to both customers and mass market retailers. Customers may easily acquire information about products by visiting numerous consumer product websites offering reviews of consumer products. Customers may also access numerous websites offering identical consumer products for sale wherein a retailer behind each website competes to offer the lowest possible price on the largest number of consumer products. Customers benefit from mass marketing on the Internet because they can quickly acquire information about consumer products and then shop for the lowest possible price offered on retailer's websites located around the world. Mass market retailers also benefit from the rapid adoption of the Internet as a mass marketing medium. A mass market retailer can set up a website in any physical location in the world and sell to any other physical location in the world, thus allowing the mass market retailer to reach a large potential customer base. Furthermore, product fulfillment is made easier by fulfillment centers located throughout the world. These fulfillment centers may be fully automated using the Internet as the communications medium between the customer, the retailer, and the fulfillment center.

Mass marketing techniques deployed over the Internet are well suited to certain types of products. These types of products share certain characteristic features. Mass marketed products tend to be simple to set up and configure to suit the needs of the customer. For example, a book needs no set up or configuration at all and household appliances are designed to be simple to operate and are usually not customizable. These product characteristics allow a mass market retailer to sell to a customer without ever having to have physical contact between the mass market retailer and the customer. Another characteristic of mass marketed consumer products are that these products are primarily compared to one another by price and not by features because the products generally share identical feature sets. For example, competing coffee makers may have one operational mode with only one power switch making them identical in functionality in the eyes of the customer; therefore, the customer may select a coffee maker based strictly on price. This characteristic allows a mass market retailer to attract customers simply by adjusting pricing schedules rather than cultivating a strong retailer to customer relationship. Successfully mass marketed consumer products can be said to occupy a simple product space where feature and configuration possibilities are limited and competition between different product lines is achieved primarily by setting attractive prices for similar goods.

Some products do not lend themselves to mass marketing techniques because they have many features, the products may be highly customizable to suit an individual customer, and competition between brands is based on intangible qualities such as aesthetics and customer support and not price. These products are characterized as occupying a complex product space. Complex product spaces are created by products that are rich in functionality, have highly customizable features, and have a significant aesthetic component to either their design or their functional elements. These products also tend to command high prices in the market place. An exemplary product occupying a complex product space is a large screen television. As television screen sizes get larger, suppliers include more and more features into a television. A large screen television may be capable of accepting input from a variety of video sources, capable of providing output to a variety of audio components, and be capable of modifying its screen configuration, thus creating opportunities to customize the television by creating a home theater system. Additionally, the television cabinetry becomes an important aesthetic element in the selection process as suppliers expend additional effort to create visually dramatic designs. The complexity of choosing and setting up a complex product makes it prohibitive for a retailer to offer a complex product using mass marketing techniques because there are simply too many variables for a customer to consider when selecting a purchase. The large number of variables to consider during the selection of a complex product often leads a customer to seek personalized assistance from knowledgeable sales personnel. This level of personal customer support may be difficult to obtain from an Internet retail website.

Suppliers of complex products have traditionally responded to the need for personalized customer support by creating specialty dealer networks. These networks are usually composed of highly skilled dealers who can: help a customer learn about a complex product; help the customer to design an optimal product installation that may require additional products to be integrated into a system; and facilitate installation, setup, and configuration of the purchased product or system. Both suppliers and dealers accept that a market must be decomposed into exclusive geographic areas where only one dealer is allowed to sell a specific complex product. Geographic isolation of the dealers ensures marketplace order by removing an incentive for dealers to lower prices at the expense of customer support simply to obtain a greater market share for each dealer's own dealerships.

Suppliers of complex products and speciality dealer networks that support complex products have resisted introduction of Internet marketing into their market sectors for mutually aligned reasons. Members of the specialty dealer networks believe that Internet marketing of the complex products they sell will erode the market share of the specialty dealer networks eventually destroying the specialty dealer networks. The collapse of a specialty dealer network may hurt suppliers as well because suppliers of complex products rely on specialty dealer networks to supply the high level of customer support demanded by customers attempting to purchase complex products and systems. The weaker the specialty dealer network, the weaker the customer support supplied to the customer. Therefore, both suppliers and members of specialty dealer networks believe erosion of the specialty dealer network because of Internet sales may lead to erosion of the entire market for the complex products. However, both suppliers and members of the specialty dealer networks would like to take advantage of the possibilities of e-commerce using the Internet without eroding the strength of their existing alliances.

Therefore, a need exists for an Internet marketing system that allows for widespread dissemination of complex product marketing efforts while still maintaining the geographic separation required to support specialty dealer networks. The present invention meets such need.

### BRIEF DESCRIPTION OF THE DRAWINGS

The features, aspects, and advantages of the present invention will become better understood with regard to the following detailed description, accompanying drawings, and appendix where:

FIG. 1 is a use case diagram of an exemplary mass marketing system deployed over the Internet;

FIG. 2 is a sequence diagram illustrating a sales model for a complex product;

FIG. 3 is a use case diagram of a “hub and spoke” marketing system according to the present invention;

FIG. 4 is an overview of the system architecture of hub in a hub and spoke marketing system;

FIG. 5 is a data flow diagram within a hub of a hub and spoke system illustrating the “Learn” process;

FIG. 6 is a sequence diagram of the learn process;

FIG. 7 is a data flow diagram within a hub of a hub and spoke system illustrating the “Build” process;

FIG. 8 is a sequence diagram illustrating the “Build” process;

FIG. 9 is an illustration of creation of an attribute vector used to match user system cases to customer questionnaires;

FIG. 10a is an illustration of creating an index using attribute vectors;

FIG. 10b is a flowchart of the process illustrated in FIG. 10a;

FIG. 11a is a process flow diagram showing how a system case is matched to a customer questionnaire;

FIG. 11b is a process flow diagram showing how a subsystem case is matched to a part of a customer questionnaire;

FIG. 12 is a data flow diagram of data flow within a Dynamic Merchandising Technology (DMT) system implemented using a hub and spoke marketing system;

FIG. 13 is a data flow diagram illustrating how a virtual database is created according to the present invention;

FIG. 14 is an illustration of data flow in a hub of a hub and spoke system for the “Buy” process;

FIGS. 15a-j are screen captures of a specific implementation of a merchandising portal created using the hub and spoke architecture;

FIG. 16 is a process flow diagram for determining if a customer can buy a recommended system;

FIG. 17 is a screen capture of a recommended system display webpage as displayed on a web browser;

FIG. 18 is a component purchase webpage as displayed on a web browser in response to selection of the buy components icon of FIG. 17;

FIG. 19 is a process flow diagram of determining if a recommended system may be bought online;

FIG. 20 is a dataflow diagram for an embodiment of a support engine; and

APPENDIX A is a CD-ROM containing source code listings for a complete hub and spoke Internet based server and a complete dealer gateway.

### DETAILED DESCRIPTION OF THE INVENTION

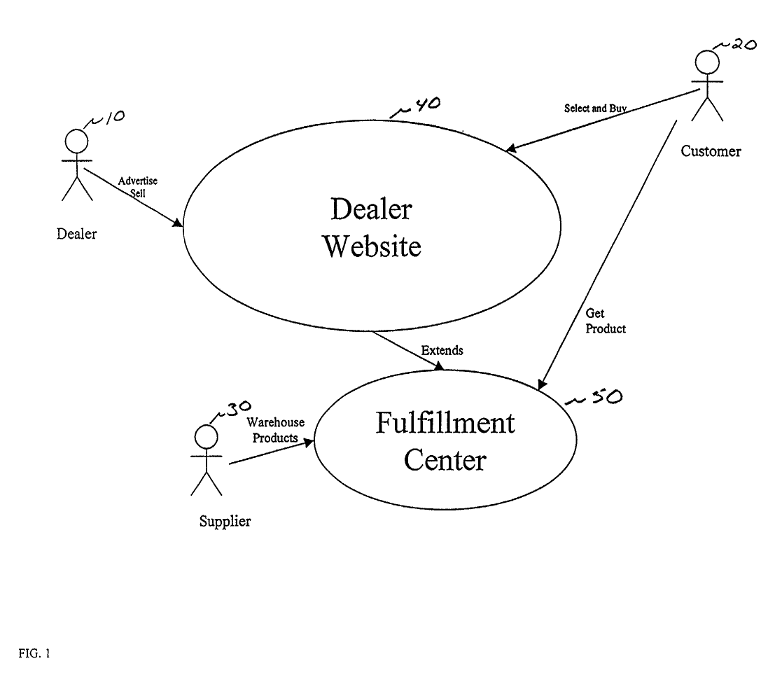

FIG. 1 is a use case diagram of how a typical Internet based mass marketing website is used by customers, dealers, and suppliers to buy and sell mass marketed products. A dealer 10 establishes a dealer website 40 on the Internet. The dealer website contains all of the information necessary for a customer 20 to buy a product from the dealer including facilities to buy and pay for a purchase. Once a purchase request has been accepted by the dealer website, the actual product must be shipped to the customer. To do so, the website's functionality is extended by a fulfillment center 50. A fulfillment center warehouses products shipped to it by a supplier 30 so that the products can be shipped to the customer when shipment is requested by the dealer. The dealer website may be extended by a plurality of fulfillment centers physically located anywhere the dealer wishes. Each of the fulfillment centers may be electronically linked to the dealer website so that orders may be electronically transmitted to the fulfillment center from the dealer website. The dealer website is used by the customer to browse the products offered by the dealer. If a customer buys a product from the dealer website, the fulfillment center is contacted by the dealer website and the fulfillment center ships the product to the customer. A feature of this scenario is that all contact between the customer, the dealer, and the supplier is mediated through the dealer website or the Internet, there is no physical or verbal contact between the customer and the dealer. Furthermore, the dealer may control the entire sales interaction by setting all of the marketing rules for the interaction, such as what prices to set for the products and which products are bundled together. The customer can either accept or reject the pricing structure but neither the customer nor the supplier can change the marketing rules for the interaction.

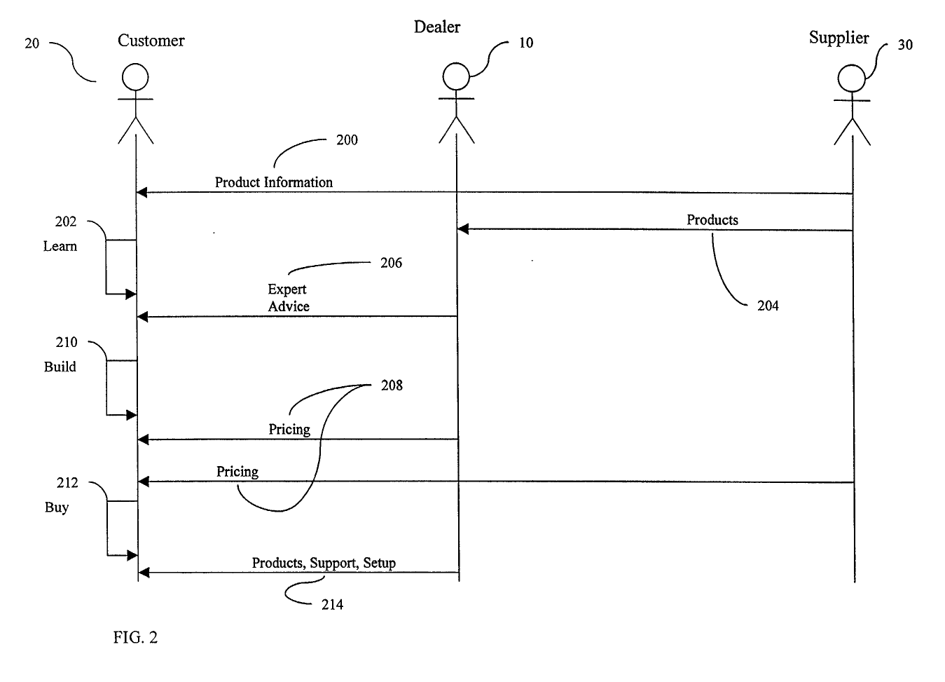

FIG. 2 is an alternative sales model applicable to purchase of products within a complex product space. A customer 20 educates himself about the product space. The customer does so by acquiring product information 200 from a plurality of supplier as exemplified by supplier 30. The customer uses the product information to learn 202 about the product space. In doing so, the customer is deciding what features the customer desires for a given product. For a complex product, like a home theater system, the customer must integrate several subsystems or products to create a product that is really a system composed of subsystems or products. The customer contacts a dealer 10 and obtains expert advice about how to build 210 a system. The build process may take a long period of time and several configurations may be proposed and discarded before a final system is decided upon. The customer must determine how much the system will cost. To do so, the customer may obtain pricing data from the dealer and the supplier. The supplier may offer coupons or special discounts on particular items and the customer must evaluate these coupons and discounts. The dealer may also offer their own coupons or discounts based on how the dealer perceives the customer is progressing in the customer's decision making process. The customer buys 212 a system and the dealer supplies the products, support, and setup 214 needed to commission the system. The customer's decision making process can be termed a four step process of “Learn, Build, Buy, and Support” (LBBS) This is the sales model that may be supported by the method and system of the present invention.

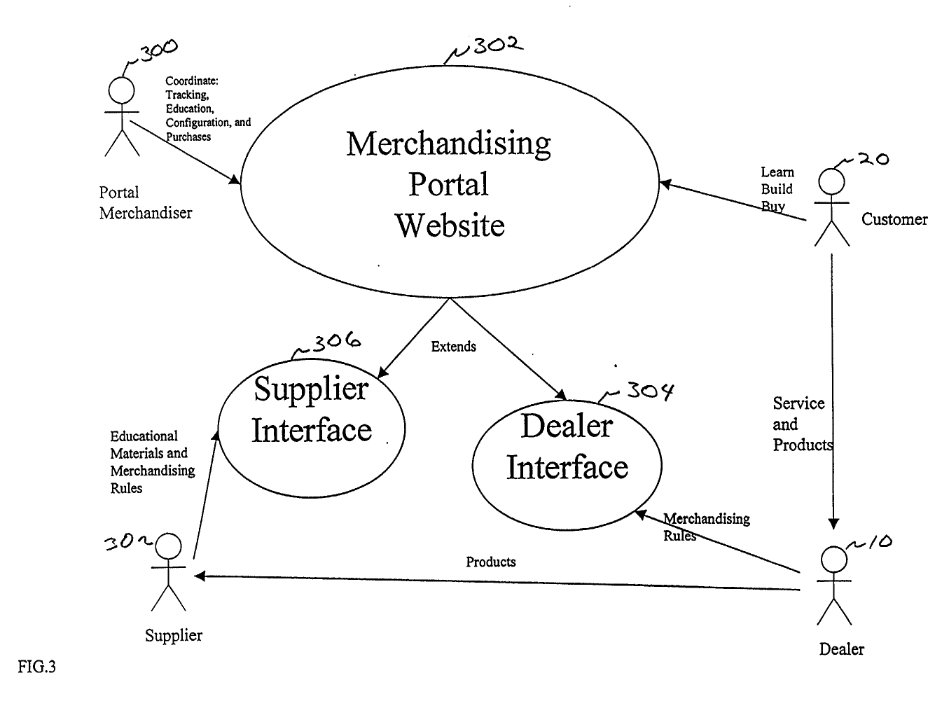

FIG. 3 is a use case diagram of an e-commerce merchandising portal Internet website supporting the LBBS sales model according to the present invention. In this scenario, a Website serves as a merchandising portal that enhances interaction between a plurality of customers, suppliers, and dealers. A portal merchandiser 300 establishes a merchandising portal website 302 on the Internet. The portal merchandiser tracks customer interaction with the Website and with the dealers, educates customers about the products offered through the portal, helps customers configure systems, and helps customers to finally make a purchase. The merchandising portal website is extended by a plurality of supplier interfaces 306. A supplier interface is used by a supplier 30 to present educational materials to the merchandising portal website and to set marketing rules used by the merchandising portal website to promote the supplier's products to the customer. Marketing rules include information such as direct customer discounts offered by the supplier, preferred product configurations, and availability of products. The merchandising portal website is further extended by a plurality of dealer interfaces 304. A dealer interface is used by a dealer 10 to set merchandising rules used by the merchandising portal website. A dealer sets merchandising rules such as special prices and product availability. The dealer also creates model product configurations based on the dealer's knowledge and expertise within the product space. A customer 20 accesses the merchandising portal website to learn about the products available through the merchandising portal website, to build product and system configurations, and to buy products and systems. A feature of the scenario is that the customer does not necessarily receive support or products from a fulfillment center, instead the customer may receive support and products directly from a dealer located in close physical proximity to the customer. This preserves the dealers position in the speciality marketing distributorship model. The dealer receives products from the supplier and the supplier may or may not deliver products directly to the customer. Many dealers and many suppliers may be supported by the merchandising portal website, each of them supplying marketing rules that influence the behavior of the customer's interaction with the merchandising portal website. Examination of this use case scenario reveals a central merchandising portal website with a plurality of dealer and supplier sites feeding into it. This structure resembles a hub located at the merchandising portal website with numerous spokes composed of supplier and dealer interfaces radiating from the central hub. This architecture is termed a “hub and spoke” architecture according to the present invention.

System Architecture

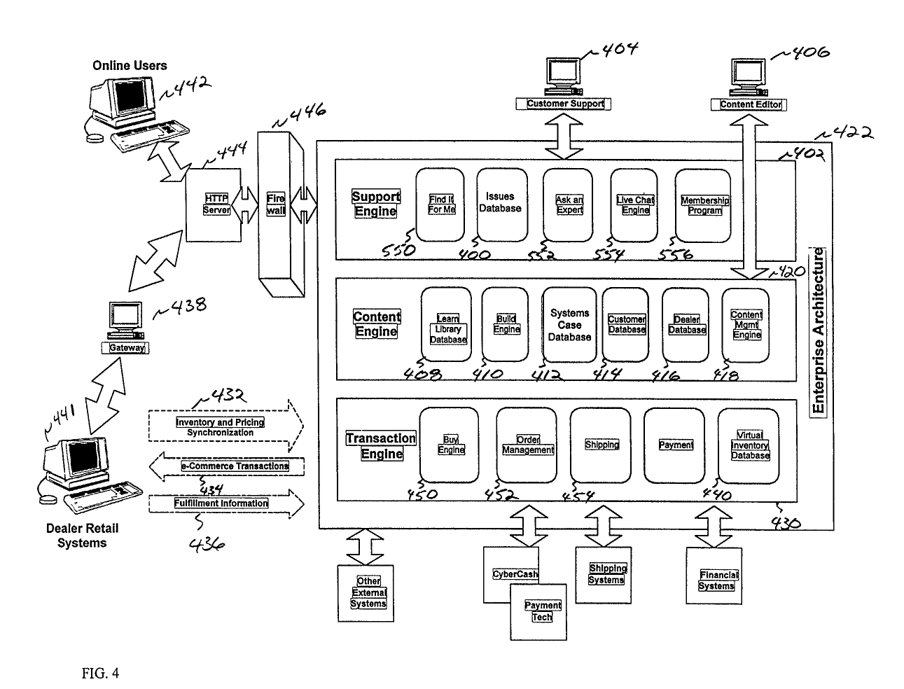

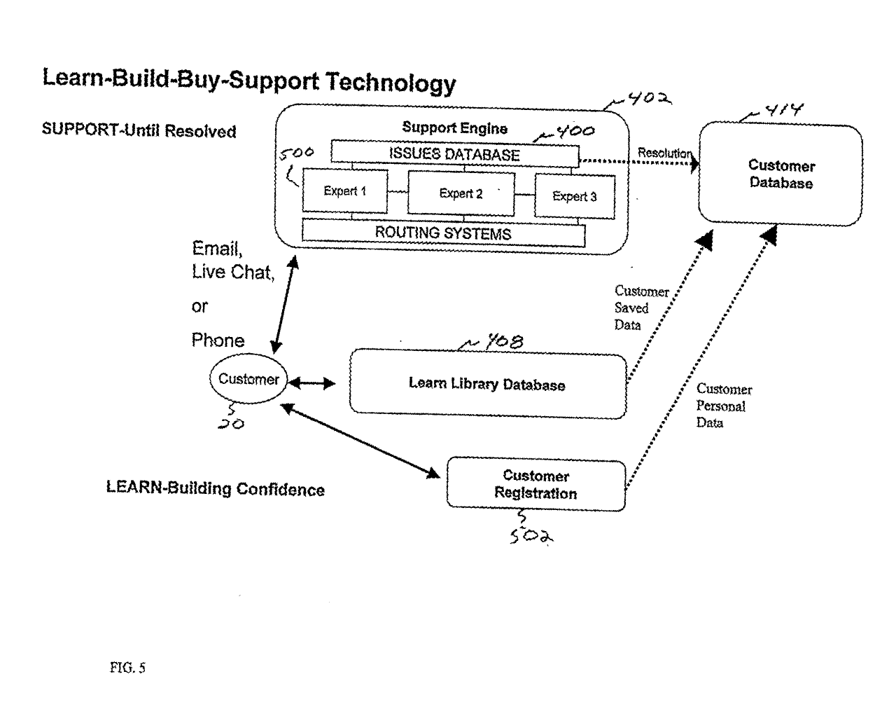

FIG. 4 is a diagram of a portal architecture that may be used as a hub for a hub and spoke implementation. A hub 422 has three components, a support engine 402, a content engine 420, and a transaction engine 430. The support engine contains modules for maintaining a high level of customer support during the selection and purchase of products. A customer can access the “Find it for me” 550 feature of the portal to request that a particular product be found by the portal's support personnel. This feature is useful when the customer selects a product for which there is no local dealer. The customer may request portal support personnel to find a dealer outlet for the product so that the customer can purchase the product. The customer may access portal support personnel via the live chat engine 554, by e-mail via the “Ask an expert” module 552, or by phone. The support engine is supplemented by live operators using a customer support interface 404. The support engine also implements a membership program 556 that collects demographic data from the customer base and keeps customers apprized of the status of the merchandising portal and website. The content engine contains modules that allow a customer to learn about products and configure a system using the products offered by dealers through the portal. The content engine also contains a customer database 414 that the customer can use to save intermediate data and that the portal merchandiser can use to track the actions of a customer. The content engine contains a learn library database 408 of data about products available through the portal. The product data typically contains detailed descriptions of how the product's theory of operation distinguishes if from other product offerings and how the product is integrated into a larger system. This information is preferably presented in nontechnical language with an emphasis on the features and benefits that are directly perceptible by the customer. A build engine 410 enables a customer to configure a system using design criteria established by the customer. The build engine matches specific system recommendations supplied by dealers with the customer's design criteria. The actual matching process will be described in greater detail later in FIGS. 7-11. A systems database 412 contains system configurations used by the build engine to build system recommendations. A dealer database 416 contains information about each dealer participating with the portal. The portal merchandiser maintains the content engine using a content management engine 418 accessed via a content editor interface 406. The transaction engine contains a buy engine 450 used to allow a customer to buy and pay for a product. The transaction engine also contains modules allowing the portal merchandiser to manage orders 452, arrange for shipping 454, and manage a virtual inventory database 440.

The hub communicates with a plurality of dealer retail systems 441 via a gateway 438. The gateway allows the hub to interface with a legacy dealer retail systems that may not be able to communicate using the Hyper Text Transport Protocol (HTTP) suite of communications protocols. From the gateway, the dealer may use a dealer retail system to synchronize inventory and pricing rules 432, receive data about e-commerce transactions 434 that occur on the merchandising portal website, and supply order fulfillment information 436. The hub also communicates to a plurality of online users 442 via a HTTP server 444 isolated from the hub by a firewall 446.

FIG. 5 is a data flow diagram illustrating how the afore described hub architecture supports the Learn step of the LBBS process. Customer 20 consults a learn library database 408 of product information. This information may be neutral in tone in the sense that a particular supplier's products are not promoted instead, the general attributes of a products within the product space are displayed in a conversational tone. The learn library database is populated by the portal merchandiser based on input from suppliers, publishers within the subject industry, and knowledge generated internally to the portal merchandiser. At this stage, the customer may use a customer registration service 502 to register with the merchandising portal website. The customer is asked for an indicator of physical location, such as a zipcode, so that the merchandising portal website can match the customer to a local dealer. The customer browses through the learn library database and stores data sheets on specific products in the customer database. The customer may use the services of a support engine 402 to contact a plurality of human experts 500. These experts may be contacted by Email, live chat, or telephone.

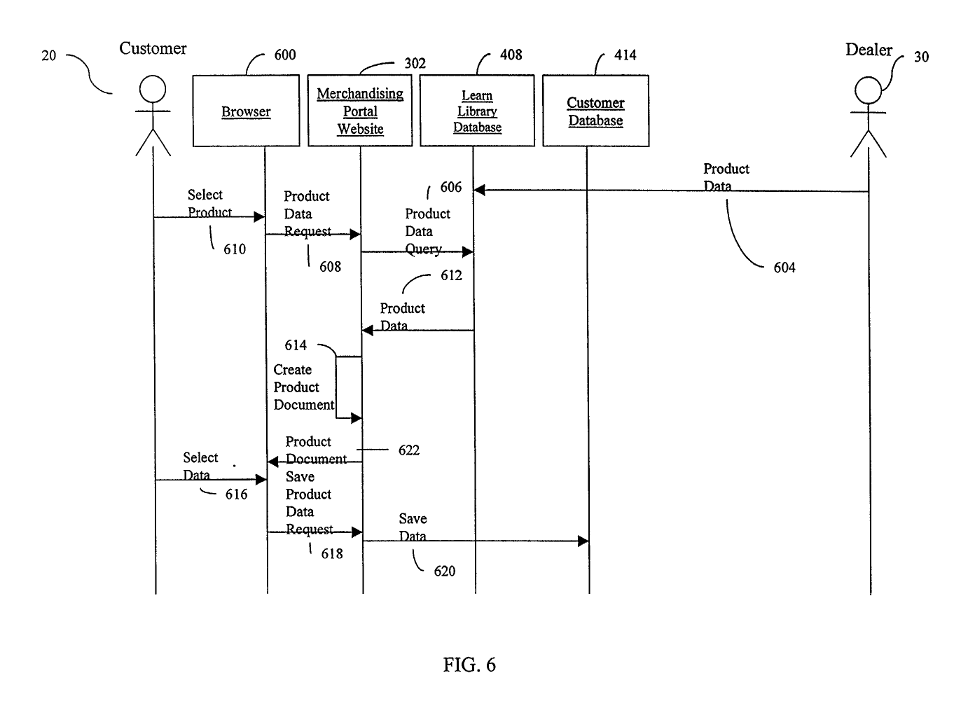

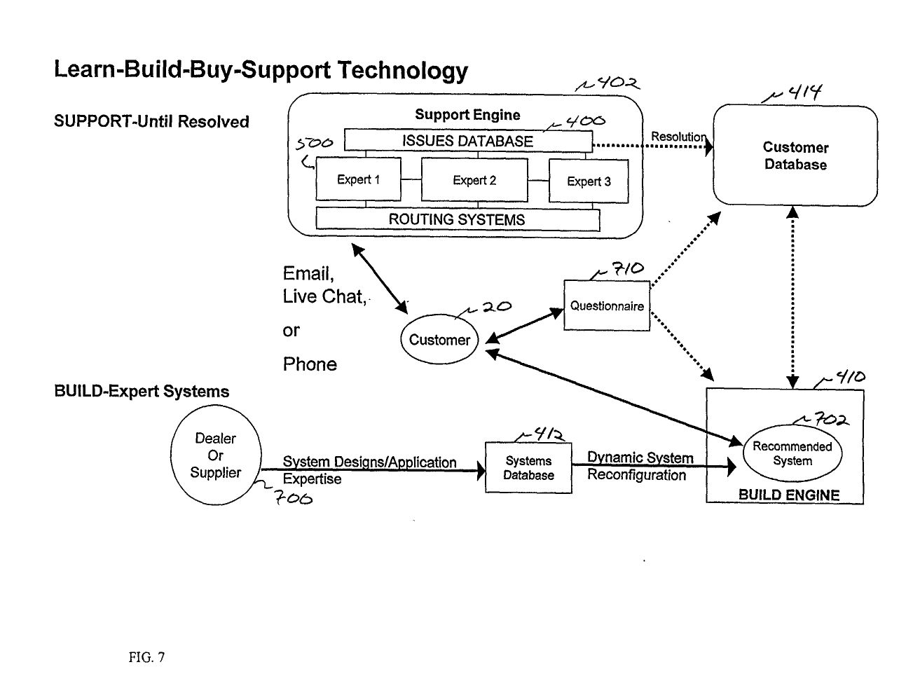

FIG. 6 is a sequence diagram illustrating the steps of the learn portion of the LBBS process. A supplier, publisher, merchandising portal staff, or contractor 30 sends product data 604 to learn library database 408 where the product data is stored for use by a customer. A customer 20 uses browser 600 to contact the merchandising portal website. The customer selects a product 610 from a document displayed by the browser. The browser creates a product data request 608 from the customer selection and sends the product data request 608 to the merchandising portal website. The merchandising portal website creates a product data query 606 and sends the product data query to the learn library database 408. The learn library database returns the requested product data 612 to the merchandising portal website. The merchandising portal website creates 614 a product document 622 and sends the product document to the browser. The customer may select data 616 from the product document. The browser formats the selected data into a save product data request 618 and sends the request to the merchandising portal website. The merchandising portal website saves the product data 620 in the customer database for later review by the customer. In this way, the customer accumulates a personalized database of products and features the customer wants in a final system configuration.

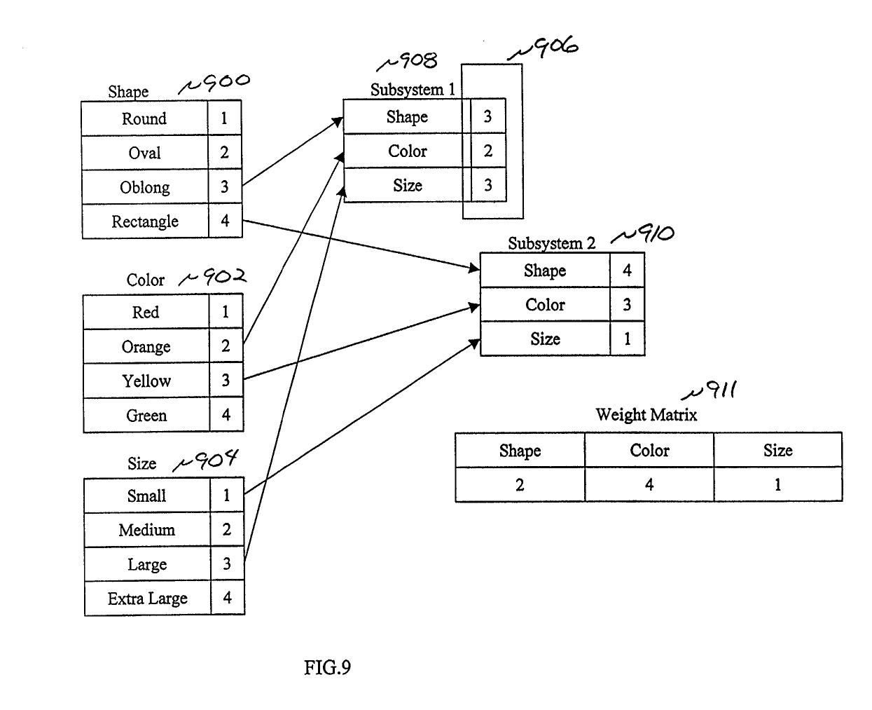

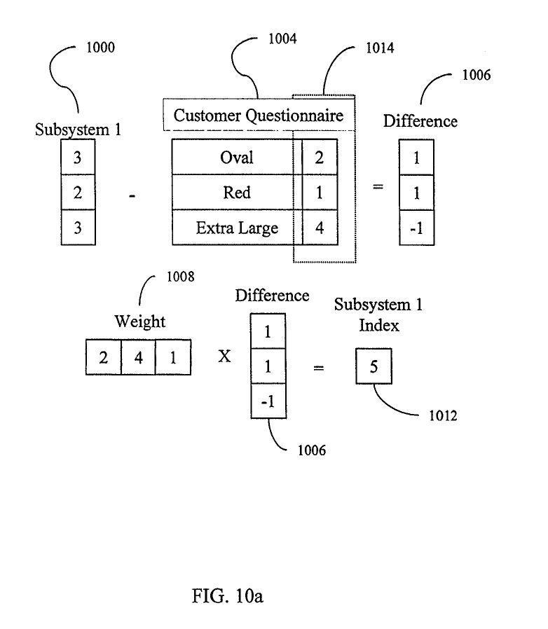

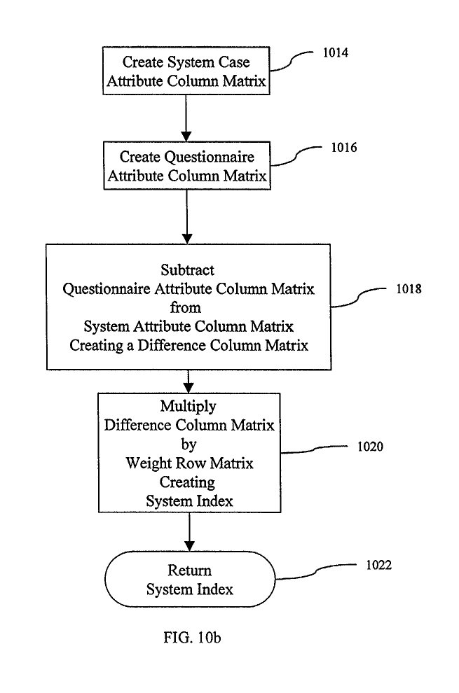

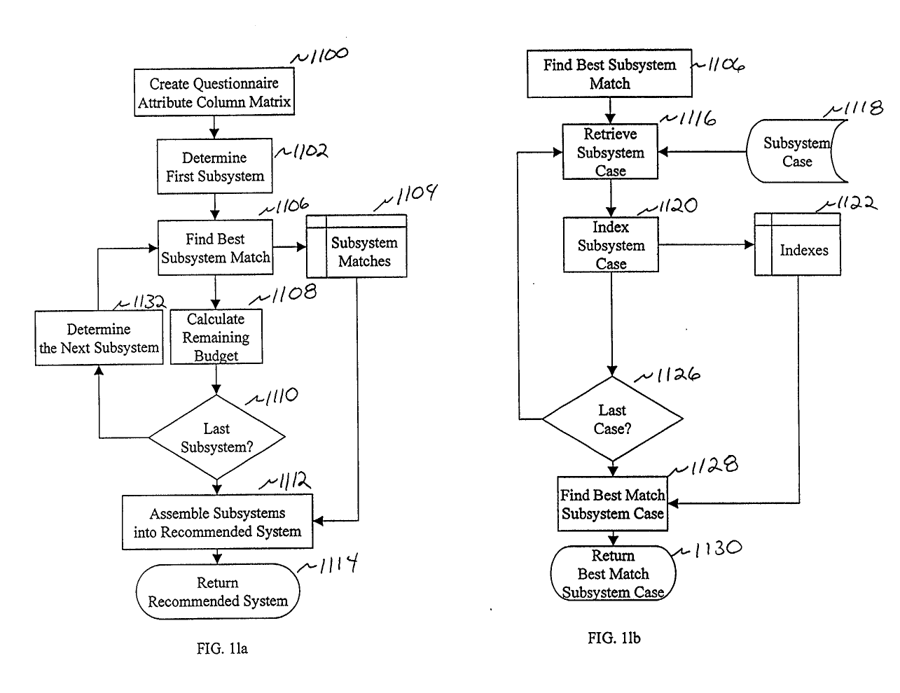

FIG. 7 is data flow diagram illustrating the Build step in a LBBS process according to the present invention. Dealers and suppliers 700 create system configurations and store them in a systems database 412. Each system configuration is termed a systems case. A customer 20 fills out a questionnaire 710 concerning customer product feature preferences. The questions in the questionnaire are preferably in terms that the customer can understand. For example, if a customer wants a home theater system, the customer may be asked to select the kind of movies the customer likes to watch. If the customer answers “action films” then an appropriate home theater system will have extra sound reinforcement features. The customer is preferably not asked “do you want extra sound reinforcement”. The questionnaire is used by a build engine 410 to select a recommended system 702. The customer is preferably paired with a dealer based on the customer's physical location stored in the customer database. The paired dealer's system configurations stored in the systems database are preferably used by the build engine to recommend a system. The recommended system is that system case specified by the customer's paired dealer which most closely matches the customer's questionnaire. The preferred matching process is illustrated in FIGS. 9 and 10. The customer is allowed to modify the recommended system by upgrading or downgrading the subsystems within the recommended system. Each of the upgrades and downgrades is preferably specified as part of the same system case used to create the recommended system. This ensures a completed system is composed of compatible subsystems as determined by the dealer creating the system cases. Alternatively, the applicable questionnaire attribute is adjusted for the applicable subsystem only and re-indexing performed to find a different system case. The recommended system is stored in the customer database 414 for later use by both the customer and the merchandising portal website. The customer is preferably encouraged to use the services of support engine to contact the previously described plurality of experts 500 in the event the user cannot create a desired system.

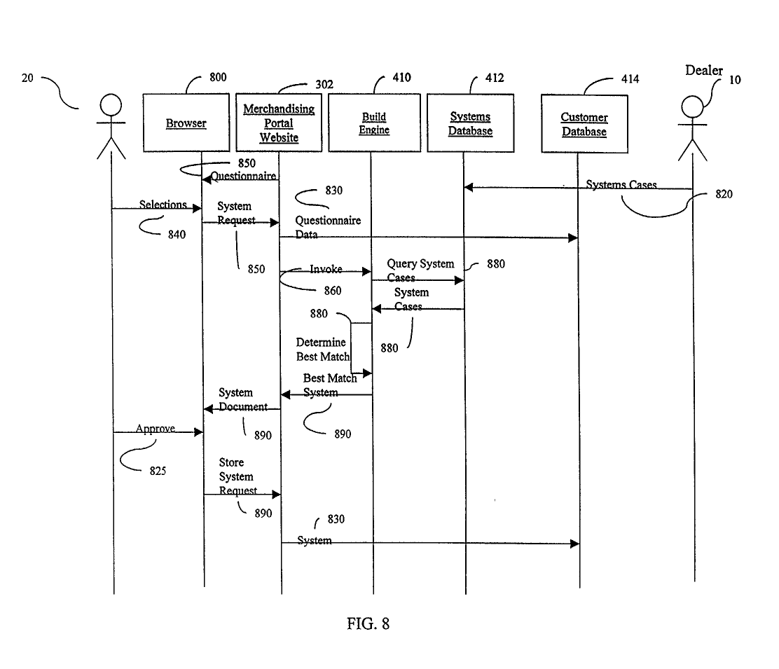

FIG. 8 is a sequence diagram of the build step of the LBBS process. A dealer 10 submits a plurality of system cases and stores them in a systems database 412. Preferably, only the dealer system cases submitted by the customer's paired dealer will be used by the build engine to create a recommended system. A customer 20 uses a browser 800 to request and receive a previously described questionnaire 850 from the merchandising portal website. The user makes selections 840 from the questionnaire until the questionnaire is filled out. The browser formats the data in the questionnaire into a system request 850 and sends the system request to the merchandising portal website. The merchandising portal website sends the questionnaire data 830 to a customer database 414. The merchandising portal website invokes a build engine 410 and sends the questionnaire data to the build engine. The build engine queries the systems database for system cases from the customer's paired dealer. The build engine receives systems cases 880 from the systems database and determines the system case that most closely matches the customer's questionnaire using a fuzzy logic algorithm to be described. The best matched system case 890 is sent to the merchandising portal website where the system case is formatted into a system document 890 describing the recommended system. Alternatively, a hierarchical list of system cases is sent to the merchandising portal website. The hierarchical list is structured so that recommended systems can be extracted from the hierarchical list from the most closely matched system to the least closely matched system. The hierarchical list is used to suggest alternative recommended systems that are still closely matched to the system requirements specified in the customer questionnaire. The system document is sent to the browser and displayed to the customer. The customer approves 825 the recommended system and the browser sends a request to store the system 890 to the merchandising portal website. The merchandising portal websites sends the recommended system 830 to the customer database for further use. In an alternative embodiment, the customer may alter the recommended system by upgrading and downgrading subsystems within the system.

FIG. 9 is an illustration of how a system case or a customer questionnaire are encoded for comparison according to the present invention. Each system is composed of a set of subsystems and each subsystem is composed of a set of attributes. Alternatively, a system may comprise a single product in which case the single product's attributes are used to describe the system. In the example of FIG. 9, a subsystem is composed of three attributes, shape, color, and size. Except for size, shape and color are not easily transformed into a real number; therefore, an attribute to value table may be generated. An attribute value table maps a set of attributes into a set of real numbers. For example, the shape attribute value table 900 maps the shape value “round” to 1. The shape value “oval” is mapped to 2, etc. A subsystem may be described by creating an attribute column matrix based on the attribute value table in the following manner. Subsystem 1 908 is composed of the shape attribute value “oblong”, the color attribute value “orange” and the size attribute value “large”. The shape attribute value “oblong” maps to the real number 3 in the shape attribute value table. In a like manner, “orange” becomes 2 and “large” becomes 3. A subsystem may then be described as an attribute column matrix 906 consisting of the values 3, 2, and 3. In a like manner subsystem 2 910 becomes an attribute column matrix consisting of 4,3, and 1. In the example, the customer questionnaire 1004 contains a request for a subsystem with the attribute values “Oval”, “Red” and “Extra Large”. The customer questionnaire becomes an attribute column matrix containing the values 2, 1, and 4.

The attribute column matrixes created from the customer questionnaire and the system case are used to compare a customer questionnaire and a system case in the following manner. The customer questionnaire column matrix is subtracted from the system case column matrix. The resultant difference column matrix is then multiplied by a weight row matrix 911. The weight row matrix is used to give different weights to each of the attribute values. For example, the attribute “shape” is given a weight twice as great as the attribute “size” but only half the weight of the attribute “color” in the example of FIG. 9. The scalar value resulting from multiplying the difference column matrix by the weight row matrix is termed the index and is used as the measure of the closeness of the match between the customer questionnaire and the system case. If the index is 0, then the customer questionnaire and the system case are a perfect match.

In an alternative embodiment, the weight row matrix is used to implement logical rules that affect the outcome of the matching algorithm. For example, the values of the weight row matrix may be a function of the differences between the attribute values rather than simple scalar. An exemplary rule implemented in this way is that a “larger” system case can never be a close match to a “smaller” customer questionnaire. This rule can be implemented by causing a very large value to be used to weight a positive value in the “size” attribute position in the difference column matrix thus resulting in an index value with a large absolute value every time a “larger” system case is compared to a “smaller” customer questionnaire.

FIG. 10a illustrates how attribute column matrixes are used to compare a system case with a customer questionnaire. Customer questionnaire's 1004 attribute column matrix 1014 is subtracted from subsystem 1's column matrix 1000. The resultant difference column matrix 1006 is multiplied by weight row matrix 1008 creating scalar subsystem 1 index 1012 of 5.

FIG. 10b is a flow diagram of the process of calculating a system index. A system case is converted to an attribute column matrix 1014 as previously described. The customer questionnaire is converted to a questionnaire attribute column matrix 1016 as previously described. A difference column matrix is created by subtracting the questionnaire attribute column matrix from the system attribute column 1018. The difference column matrix is multiplied by a weight row matrix to create a system index 1020. The system index is returned at step 1022.

FIG. 11a is a process flow diagram illustrating how a recommended system composed of a set of subsystem cases is chosen based on a customer questionnaire. An example of subsystems within a system are the video and audio components of a home theater system. All of the video components, such as the television and video tape player, can be considered as part of the video subsystem. All of the audio components, such as the audio amplifier and satellite speakers, can be thought of as the audio subsystem. Both video and audio subsystems may need to be purchased using a single budget price. The matching begins by calculating the attribute column matrix for the customer questionnaire at step 1100. The first subsystem within the system is determined at step 1102. The best matching subsystem is determined and stored at step 1106. The best matching subsystem is stored in data store 1104. Selection of a subsystem incurs a cost that must be subtracted from the overall budget allocated for the system. The amount remaining in the budget after a subsystem is matched is calculated at step 1108. A check is performed to see if the last subsystem has been processed at step 1110. If the last subsystem has not been processed, the next subsystem is determined at step 1132 and execution resumes at step 1106. If the last subsystem has been processed, the stored subsystem matches are retrieved from datastore 1104 and assembled into a recommended system at step 1112.

FIG. 11b is a process flow diagram of an exemplary algorithm to find a best subsystem case match. The first stored subsystem case is retrieved from datastore 1118. An index for the subsystem case is determined 1120 using the customer questionnaire as previously described in FIG. 10b. Each index for each subsystem case is stored in datastore 1122. A check is performed to see if the last subsystem case has been processed at step 1126. If the last subsystem case has not been processed, execution continues at step 1116. If the last subsystem case has been indexed, the best match is chosen at step 1128 by finding the subsystem case whose index has the lowest absolute value by searching the stored indexes 1122. The subsystem case with the best match is returned at step 1130.

The merchandising portal website allows a customer to use a universally accessible website to learn about products, build a recommended system and finally buy the recommended system. Just as the merchandising portal website matches a customer with a dealer for the purposes of configuring a recommended system, the merchandising portal website matches a customer with a local dealer for pricing information. And just as the recommended system is customized for a particular customer, the pricing information may be customized for a particular customer. The merchandising portal website sets pricing information, auxiliary product recommendations, and other incentives for a particular customer using a process termed Dynamic Merchandising Technology (DMT) and through creation of a virtual inventory database.

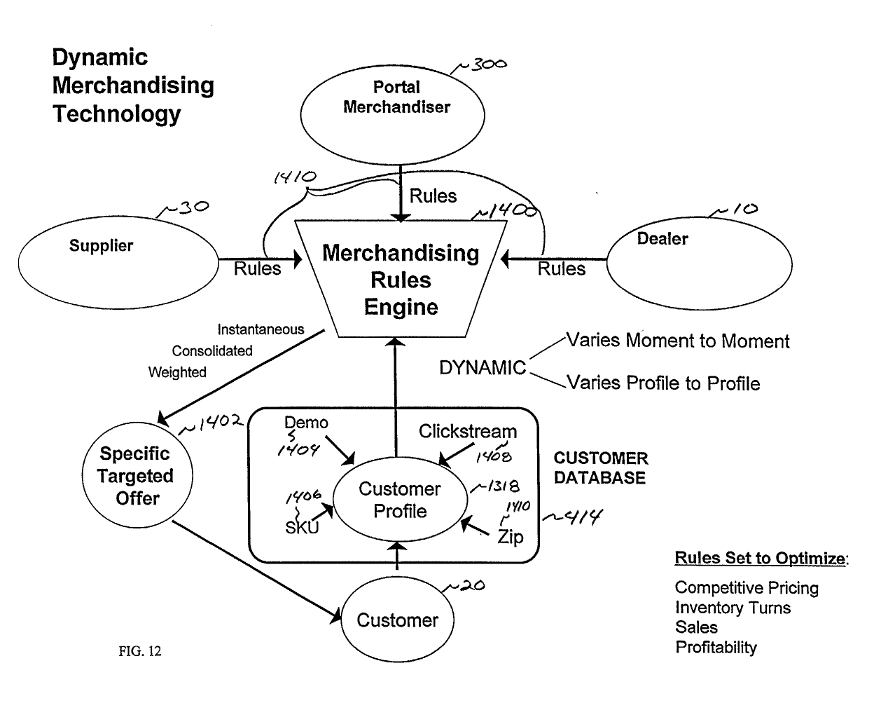

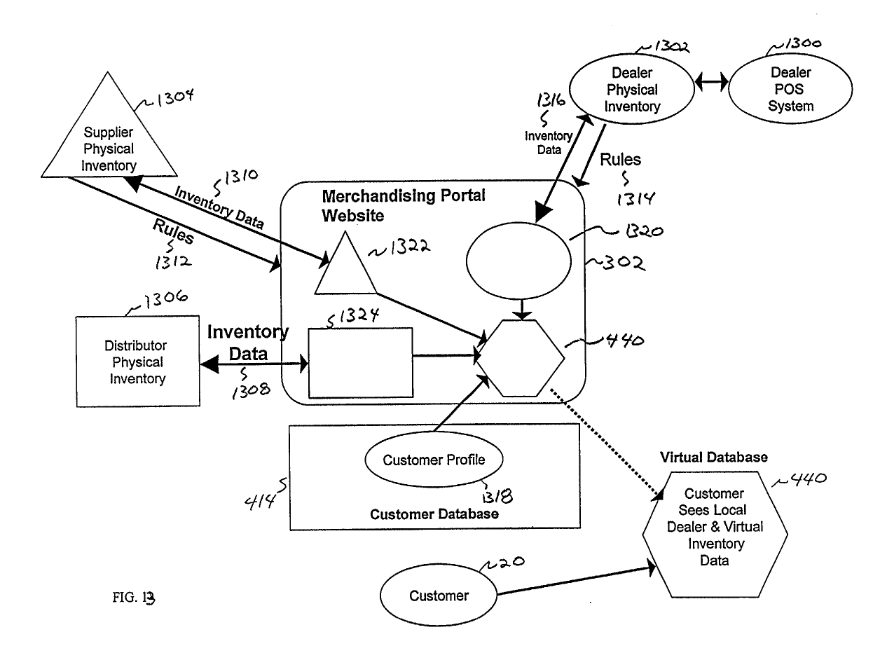

FIG. 12 is a data flow diagram of data flow within a DMT marketing system implemented using a hub and spoke architecture according to the present invention. The merchandising rules engine receives 1400 merchandising rules 1410 from a portal merchandiser 300, a supplier 30, and a dealer 10. These merchandising rules control how products are presented to a customer 20. For example, a supplier may offer three different products, each with a separate incentive. The portal merchandiser may decide to support only those products and incentives that the dealer agrees to support. The dealer may decide to stock and support only two of the supplier's three products. Incentives and product offerings may also be customized based on a customer profile 1318 stored in the customer's database 414. A customer profile comprises information compiled about the customer by tracking the customer as the customer uses the merchandising portal website. Exemplary data sources available to the merchandising portal website are the demonstrations 1404 given to the customer, the products in the customer's recommended system as tracked by their Stock Keeping Unit (SKU) number 1406, by the recorded selection of links, or clickstream, of the customer, and the zip code of the customer. For example, a first supplier may know a customer has looked at the supplier's products extensively because of the number of times the customer has chosen links to the first supplier's products (as determined by analyzing the customer's clickstream); however, the customer may have only products from a second supplier in the customer's recommended system (as determined by analyzing SKU numbers). The first supplier may then decide to send the customer a specific targeted offer 1402 intended for the customer and that customer alone. The merchandising rules may be dynamically updated through the interfaces and vary from moment to moment. Furthermore, the merchandising rules may be sensitive to customer profiles. The DMT system supplies a specific targeted offer to a customer based on merchandising rules and customer profile. This helps dealers, suppliers, and a portal merchandiser to offer competitive pricing, increase inventory turnover, increase sales, and maximize profitability by getting the best possible offer to each customer based on the individual customer's profile.

FIG. 13 is a data flow diagram for a hub and spoke system illustrating how a virtual inventory database is created and made visible to a customer based on the customer's profile. A dealer maintains a physical inventory 1302 at the dealer's physical location. The dealer may employ a dealer Point Of Sale (POS) 1300 system to continuously update the dealer's physical inventory data. The dealer physical inventory data is transferred to a customizable database 1302 hosted at the merchandising portal website 302. Dealer merchandising rules 1314 are also sent to the merchandising portal website that specify the pricing rules for the products in the dealer physical inventory. A product supplier may also maintain a supplier physical inventory 1304. The supplier physical inventory data is transferred to the merchandising portal website database 1322 along with supplier merchandising rules 1312 for presentation of the products in the database to the customer. A distributor may also make products available to the merchandising portal website. A distributor maintains a distributor physical inventory 1306 whose content data are entered into a database 1324 located in the merchandising portal website. When a customer 20 checks to see what products are available, a virtual database 440 of products is created. The availability and pricing of the products in the virtual database is based on the physical location of the customer as determined by the customer's customer profile 1318 and the product pricing rules established by a supplier, a portal merchandiser, a warehouse physical location, and a dealer. Alternatively, multiple cooperating dealers make their inventory available to each other through the virtual database. In this way, the customer is presented with a current virtual database of available products with pricing set using merchandising rules established by the dealer, supplier, and the portal merchandiser. However; the customer's view of the database is that of single database of products available from the customer's local dealer.

The customer may move to the buy step of the LBBS process any time a system is built and saved as a recommended system or whenever the customer has selected a product while touring the merchandising portal.

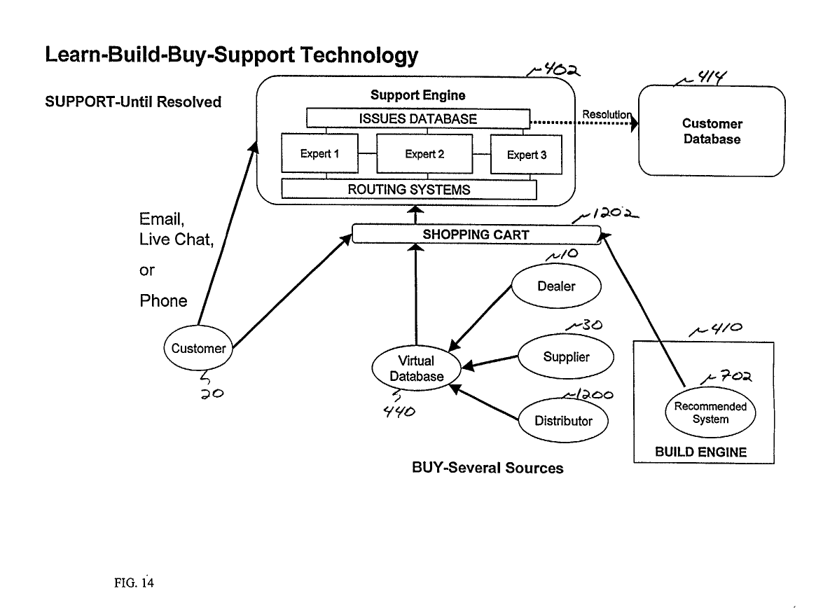

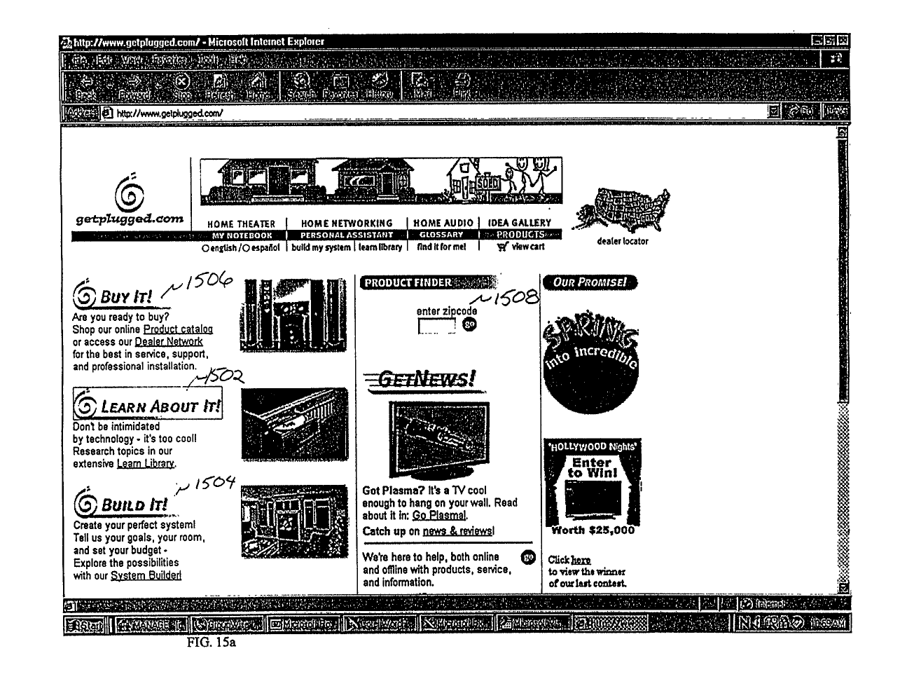

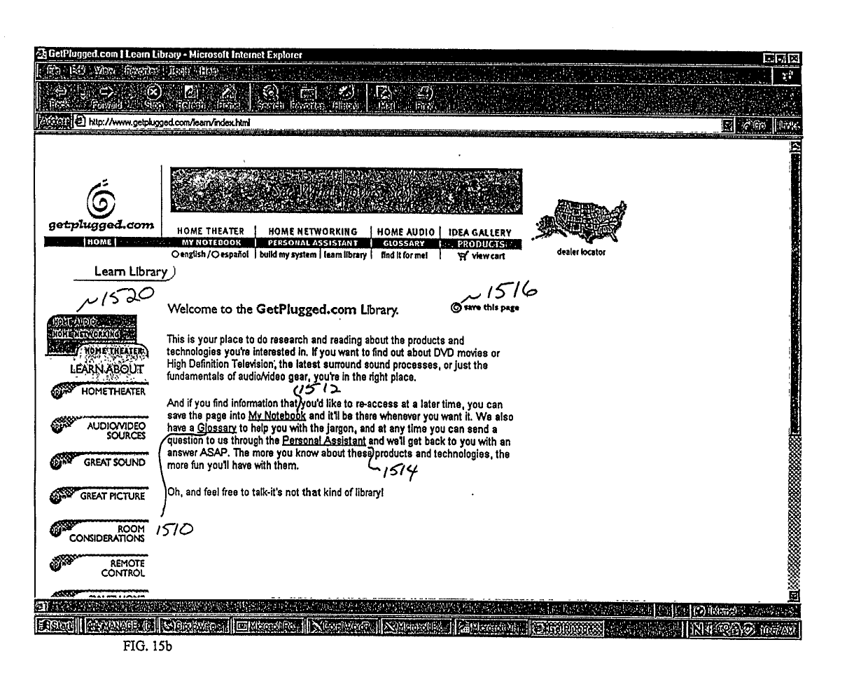

The buy step is illustrated in FIG. 14. The recommended system 702 is sent to a shopping cart engine 1202. Pricing on the products comprising the recommended system is drawn from the previously described virtual database 440 containing prices set by a dealer 10, a supplier 30, and a distributor 1200. Alternatively, a single product may be sent to the shopping cart engine such as when a customer sees a product during the learn process and wants to immediately buy the product. The product or products in the shopping cart may come from four separate sources. A dealer may have the products in inventory and the products are selected from that inventory. If a dealer doesn't have the product currently in inventory, a product may be taken directly from supplier inventory or from another cooperating dealer's inventory. Finally, a distributor may supply some of the products within the recommended system. The results of the buy phase of the process may be forwarded to the customer's customer database 414 and to the support engine 402 where the recommended system order is tracked until the order is fulfilled. The customer may use the support engine to track the progress of an order.

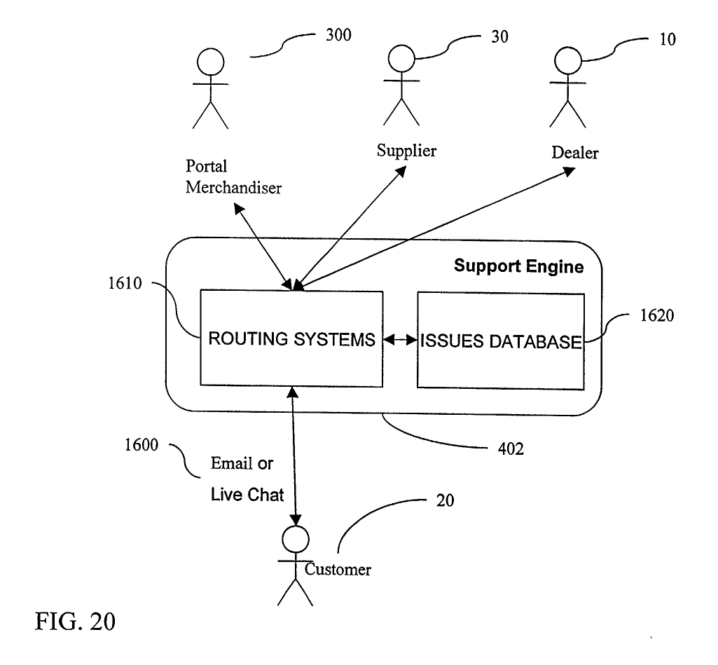

FIG. 20 is a dataflow diagram for an embodiment of a support engine. Support engine 402 is a component of a merchandising portal website and all communications between a customer and the support engine occur through webpages served by the merchandising portal website. The support engine shares the same hub and spoke architecture as the merchandising portal website. The support engine comprises two main components. Routing systems 1610 route email and live chat messages between customer 20 and experts located at the “spokes” of the merchandising portal website. Typical experts are dealer expert 10 located at a dealer physical site associated with the customer by geographical location. A dealer expert answers such questions as how separate components from different suppliers can be integrated into a larger system. Supplier expert 30 answers specific questions about individual components. Portal merchandising expert 300 answers all types of questions including questions about helping a customer use the merchandising portal website most effectively. Issues database 1620 retains records of discussions between the experts and the customer.

The LBBS process has been presented in the context of a sequential process. Alternatively, each of the individual learn, build, buy, and support processes can be initiated from any point within the LBBS sequence. For example, a customer may be in the middle of a build session and want more information about the products in a recommended system. The customer can in this case access the learn process to gather more information about a particular product before confirming the recommended system. Additionally, a customer may start in the learn process, accumulate products in a personal workspace, and jump directly to the buy process to purchase the accumulated products.

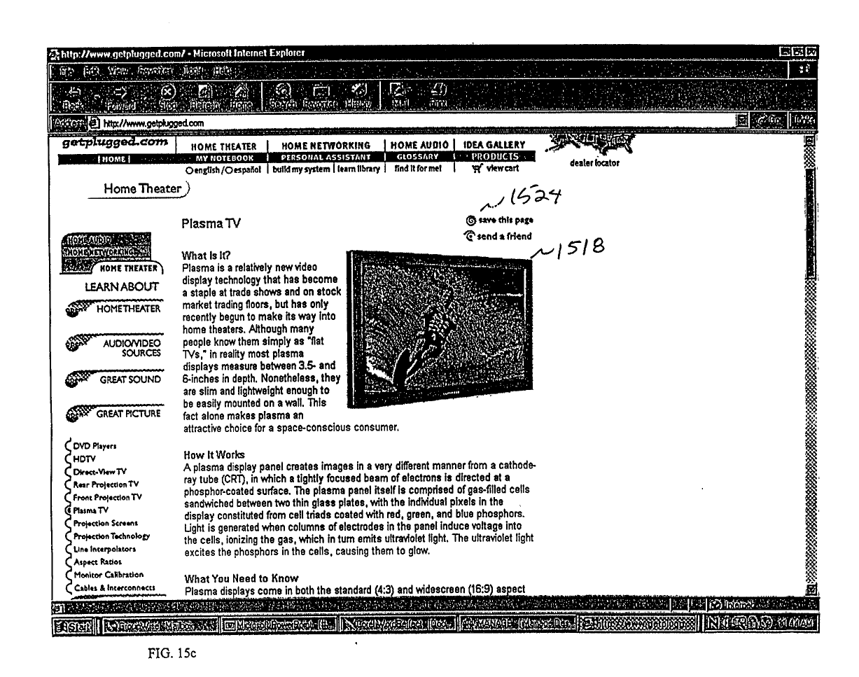

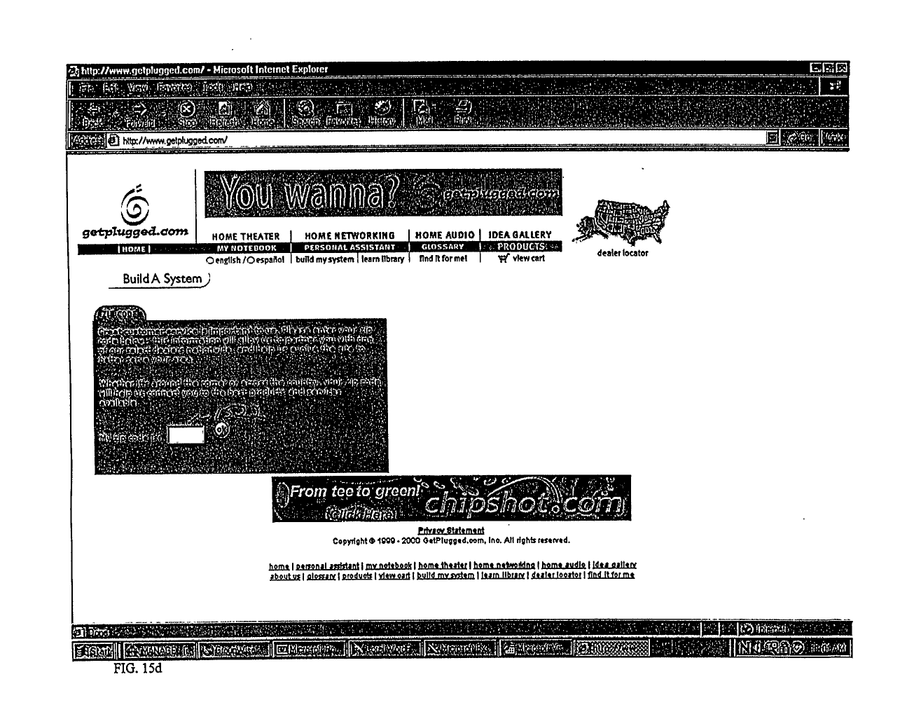

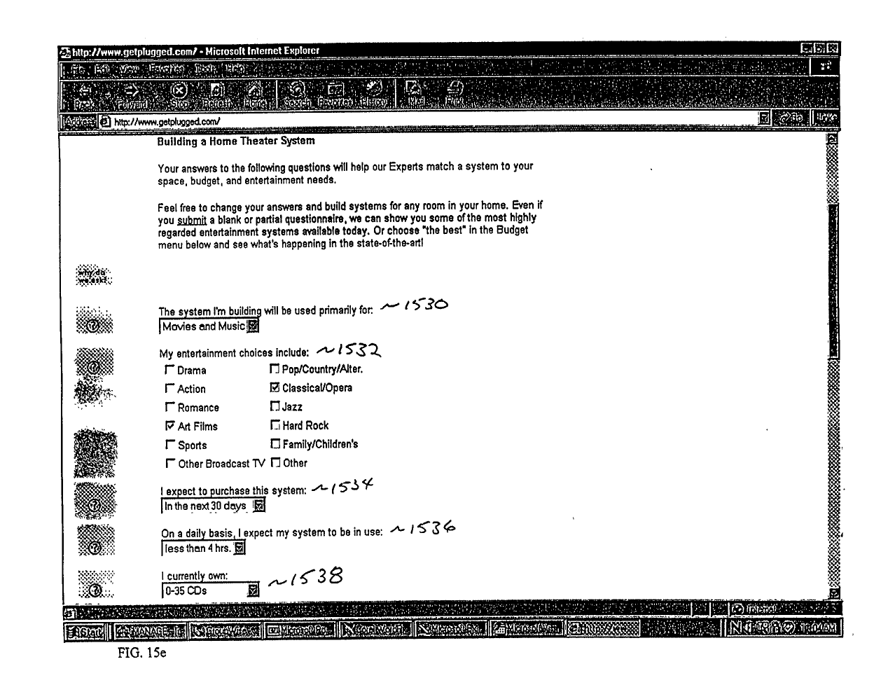

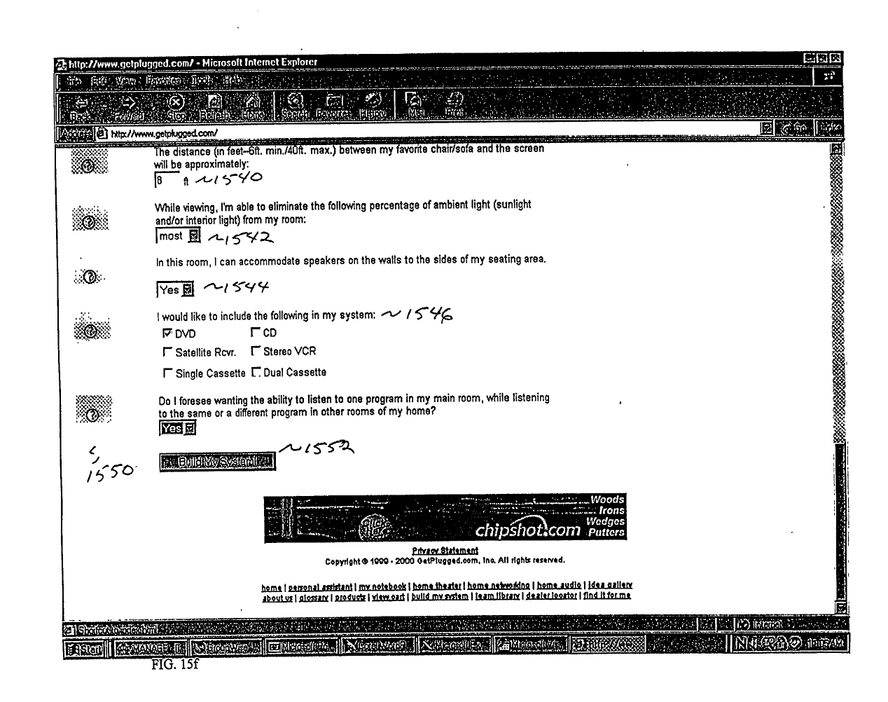

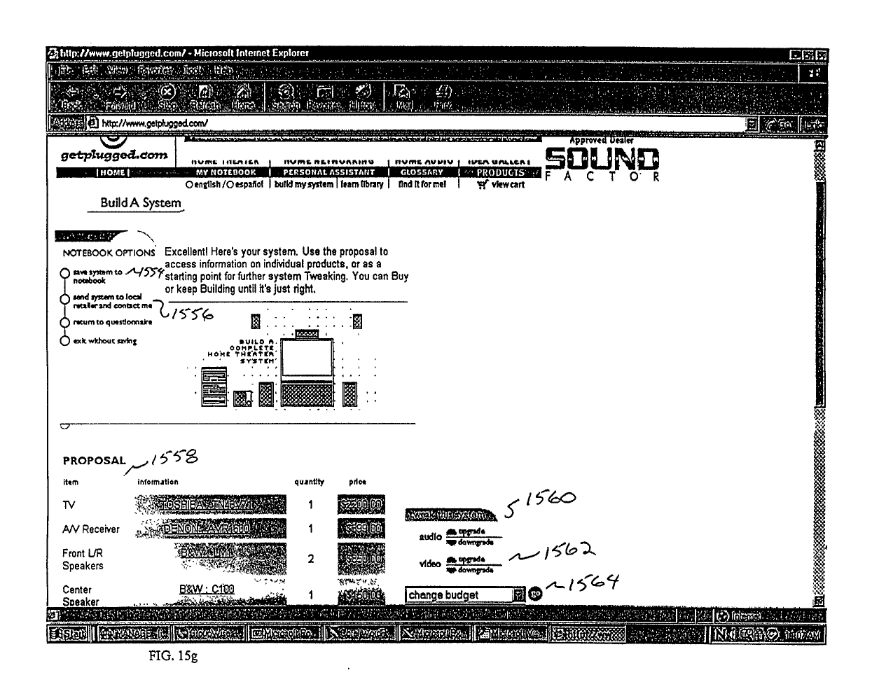

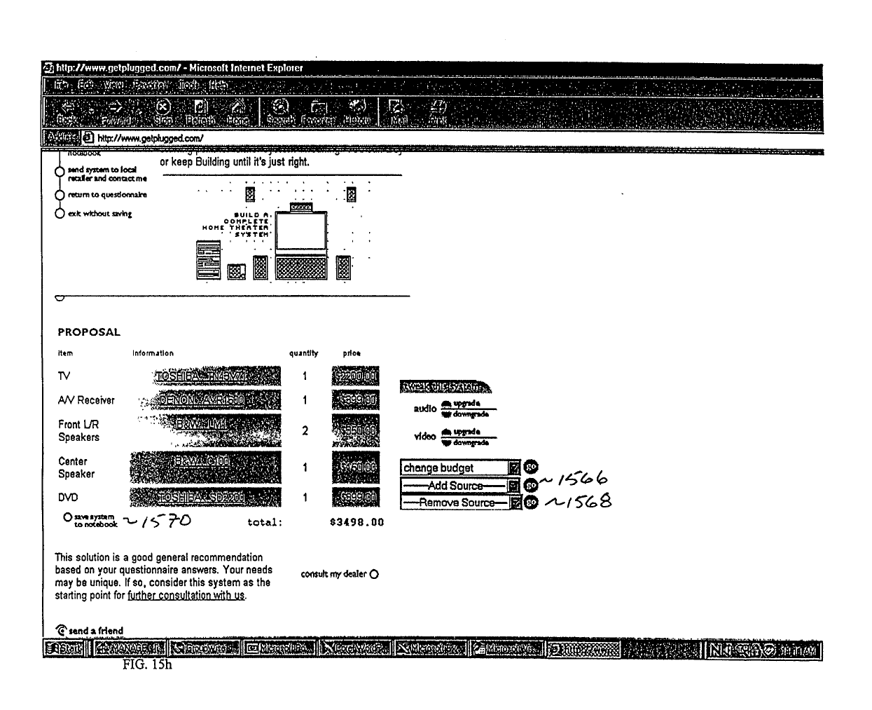

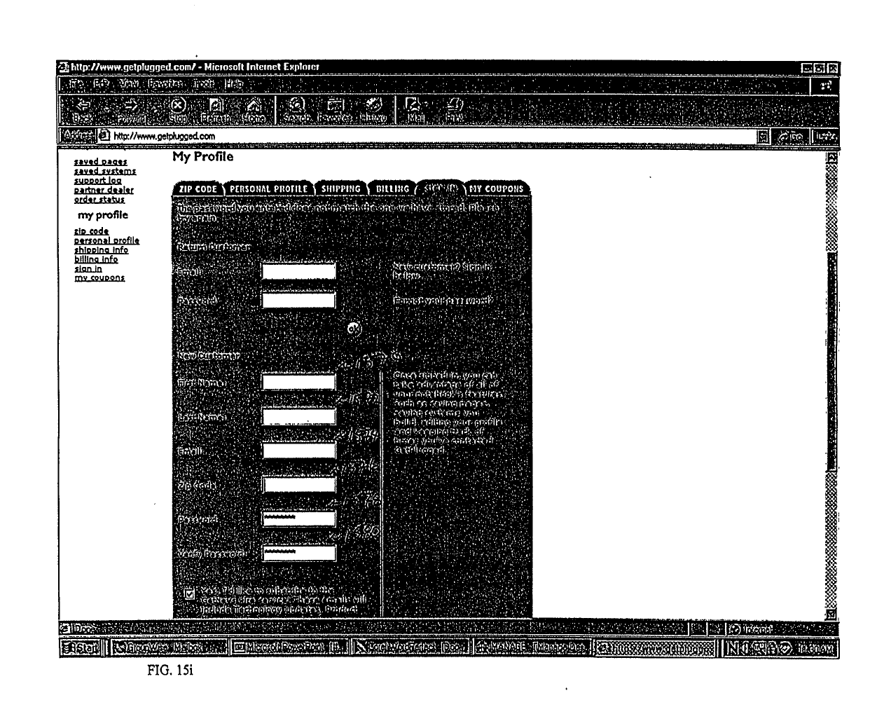

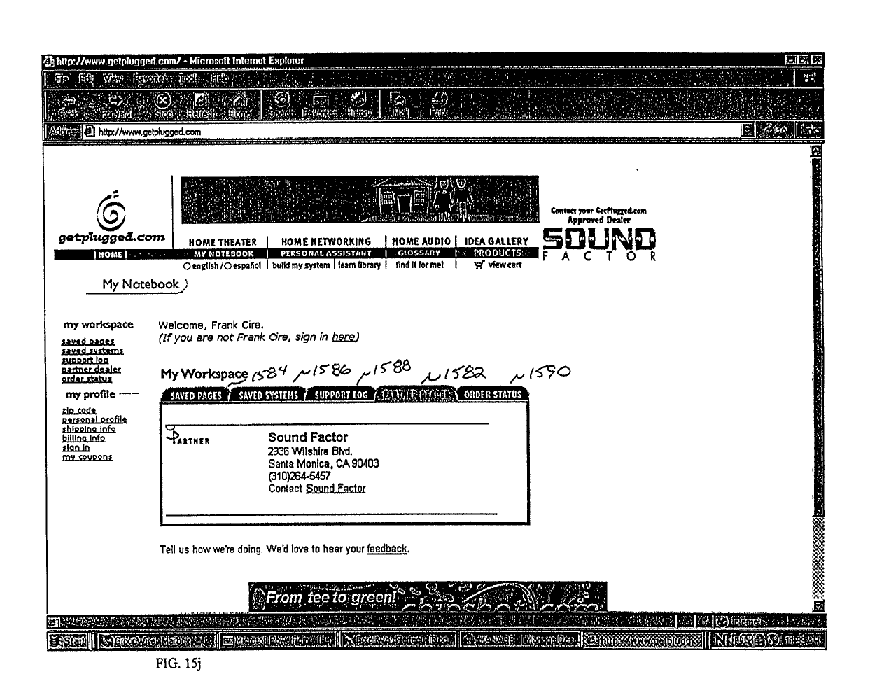

FIGS. 15a-j are screen captures of an exemplary implementation of a merchandising portal website created using the hub and spoke architecture according to the present invention. FIG. 15a is the home webpage of the merchandising portal website. A customer can select the “Learn About It” 1502 icon to begin learning about the products available through the merchandising portal. The customer can select the “Build It!” 1504 icon to begin building a customized system. The customer can select the “Buy It!” 1506 icon to purchase a recommended system created using “Build It!” or to purchase a product directly from the product catalog. The customer can also enter a zip code 1508 and use the product finder features of the merchandising portal to find a specific product.

FIG. 15b is a screen capture of a first webpage of the Learn section of the merchandising portal. The customer can select from several broad categories of consumer electronics by using the menu system on the left of the screen 1520. The webpage contains links to a glossary 1510, the setup portion of the customer's personal space in the customer database or “My Notebook” 1512, and a link to customer support personnel under “Personal Assistant” 1514. The webpage may be saved in the customer's personal space, or “My Notebook” in the customer database by selecting the “save this page” icon 1516.

FIG. 15c is a screen capture of a webpage with exemplary information from the Learn portion of the merchandising portal. A pictorial representation 1518 of an exemplary product within the general product type is made available to a customer. The copy on the webpage is designed to educate a customer about the characteristics and features of products within the product class. Preferably no recommendations as to specific products are made in the Learn portion of the merchandising portal. Each Learn webpage may be saved in the customer's “My Notebook” by selecting the “save this page” icon 1520.

FIG. 15d is a first webpage in the Build portion of the merchandising portal. At this point, the merchandising portal begins mapping customers to specific dealers because system configurations are submitted by dealers to reflect the inventory and expertise of each individual dealer. Customers are allocated to dealers and dealer configurations by requesting the customer's zip code 1522 so that a dealer in close physical proximity can be selected for the customer. Once the customer enters a zip code, a dealer may be assigned to the customer and the customer may begin specifying system criteria used to select a recommended system.

FIGS. 15e and 15f are screen captures of a Build webpage used to capture customer application and preference information for creating a customer questionnaire for a home theater system configuration. Preferably, a customer is asked about the primary purpose of the system 1530, what kind of movies and music the customer prefers 1532, how soon the system will be purchased 1534, how long the system will be on for in a given day 1536, how much music media is owned by the customer 1538, the viewing distance preferred by the customer 1540, how much control the customer has on ambient lighting 1542, whether or not surround sound speakers can be mounted on the walls of the room 1544, what special features the customer wants 1546, and whether or not the customer needs to view different input sources at different locations within the customer's home 1548. For each question the customer can find out why the question is important by selecting the “why do we ask?” icon 1550 next to the question's entry field. Once the fields are entered, the customer can select the “Build My System” 1552 button to query the system case database based on the customer's input.

FIGS. 15g and 15h are screen captures of a recommended system webpage. The customer can select “save system to notebook” 1554 to save the recommended system to the customer's notebook. The customer can select “send system to local retailer and contact me” 1556 if the customer wants to discuss the system with a local dealer. The recommended system configuration is shown as a list of the products 1558 comprising the recommended system. The customer can “tweak” the system by selecting an audio upgrade or downgrade icon 1560. Doing so selects a new system with improved or degraded audio characteristics. The customer may also “tweak” the video components in a like manner by selecting a video upgrade or downgrade icon 1562. The customer may change the budget for the system by selecting a new value in a “change budget” field 1564. Referring now to FIG. 15h, the customer may add or remove an audio or video source to or from the system using “add source” 1566 and “remove source” fields 1568. If the customer approves of the system, the customer may select the “save system to notebook” icon 1570 to save the system in the customer's personal data space in a customer database.

FIG. 15i is a screen capture of a webpage used on the merchandising portal website to collect information from the customer for setting up a personal notebook. The customer is asked for a first 1570 and last 1572 name, an email address 1574, a Zip Code 1576, and a password 1578 and 1580. The zip code is used to identify a dealer closest to the customer so that the correct virtual inventory database and pricing schedules can be created for the customer.

FIG. 15j is a webpage used by a customer to review and maintain a customer personal data space in the customer database termed a notebook. Selecting a “Partner dealer” 1582 tab reveals the dealer selected for the customer based on the customer's zip code. Selecting the “Saved pages” tab 1584 allows a customer to view and follow links to the product data pages saved by the customer when learning about products. Selecting the “Saved Systems” tab 1586 allows the customer to review and edit any recommended systems the customer may have created during the build step of the LBBS process. Selecting the “Support Log” tab 1588 allows a customer to review any resolved questions the customer may have asked of the merchandising portal website support personnel. Selecting the “order status” tab 1590 allows a customer to track any orders the customer may have made.

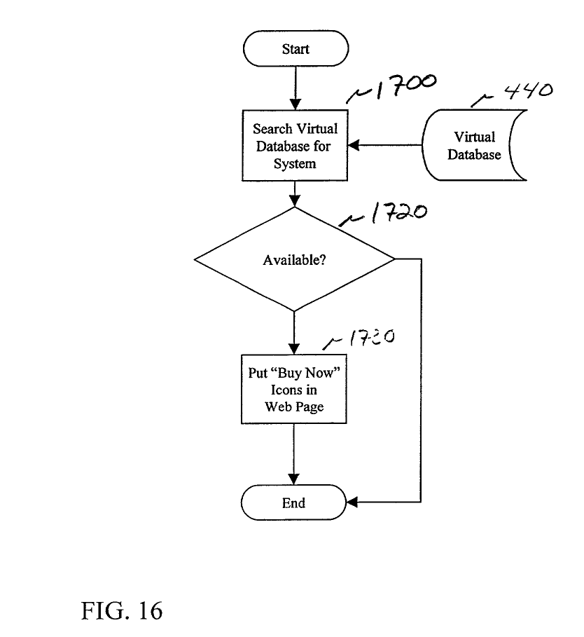

FIGS. 16-20 depict an embodiment of a buying process according to the present invention. FIG. 16 is a process flow diagram for determining if a customer can buy a recommended system. A recommended system is comprised of components. Each component may be purchased from a variety of sources. Referring to FIG. 13, virtual data base 440 is a representation of dealer physical inventory 1302, supplier physical inventory 1304, and distributor physical inventory 1306. The virtual database is used to determine if a recommended system can be purchased for available inventories. Referring again to FIG. 16, a search 1700 is made of virtual database 440 for all of the components of a recommended system. If the components are determined 1720 to be available, a webpage depicting a recommended system is created 1730 with a “Buy system now” icon. Alternatively, two icons are generated. One icon is used for buying the system on a component basis. The other icon is used to buy an entire system.

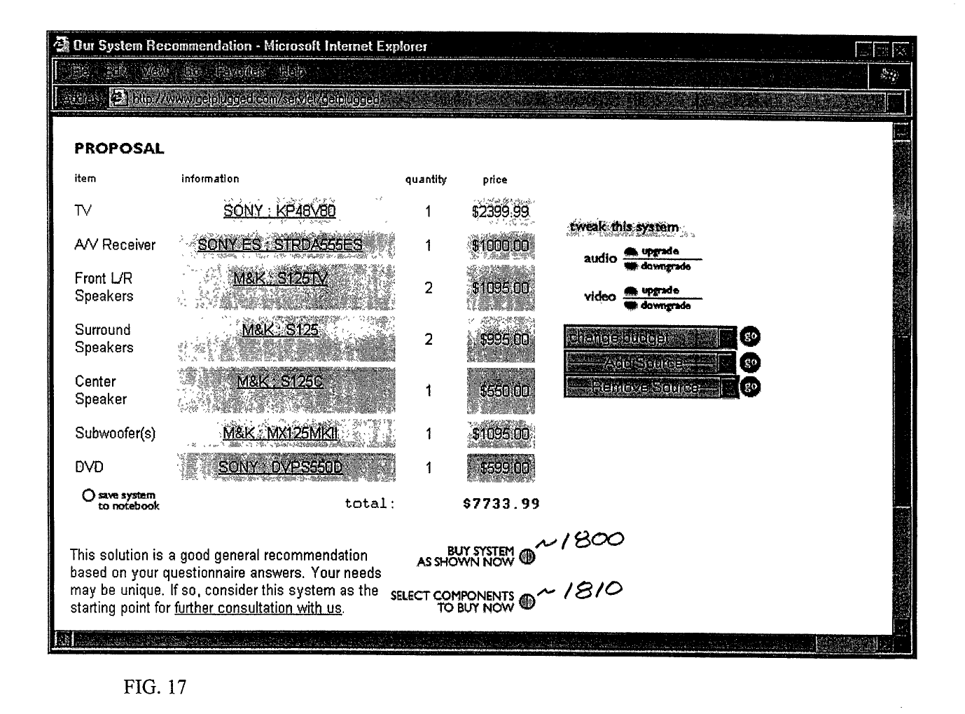

FIG. 17 is a screen capture of a recommended system display webpage as displayed on a web browser. The displayed webpage contains a “buy system” icon 1800. The buy system icon is made available if the recommended system is available for purchase using a previously described process. Selection of the buy system icon allows a user to buy a complete recommended system. The displayed webpage also contains a “buy components” icon 1810. Selection of the buy components icon allows a customer to specify which components of a recommended system the customer wants to purchase without purchasing the entire recommended system.

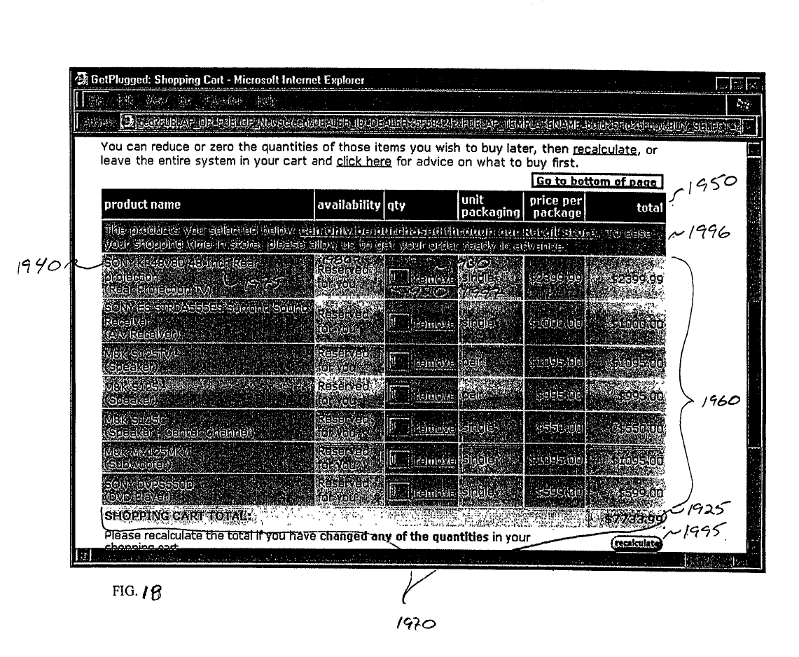

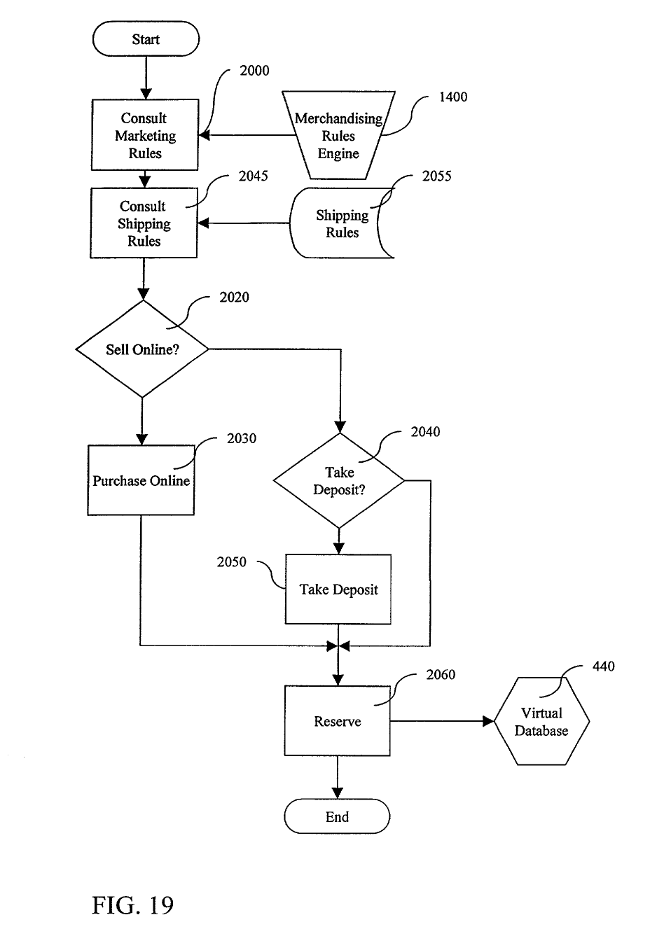

FIG. 18 is a component purchase webpage as displayed on a web browser in response to selection of the buy components icon of FIG. 17. The buy components webpage consists of table 1950 containing a plurality of rows 1950 and columns 1970. Each row corresponds to a single component of a recommended system. Exemplary row 1940 contains product name entry 1975. The product name entry within a row contains a description of a single component of a recommended system. The exemplary row contains availability cell 1980 indicating that the component of the recommended system corresponding to the exemplary row is reserved for purchase. Quantity cell 1997 contains quantity entry field 1920 and remove component selection 1930. The quantity entry field is used to directly set the quantity of a component to be ordered. The remove component selection is used to remove the component completely from the recommended system. Selection of recalculate icon 1995 causes shopping cart total 1925 to be recalculated after the quantities of the system components have been adjusted. Notification banner 1996 is used to indicate whether or not the constituent components of the recommended system may be purchased online. The process of making the online purchase determination is depicted in FIG. 19.

FIG. 19 is a process flow diagram of determining if a recommended system may be bought online. Previously described marketing rules engine 1400 is consulted 2000 to determine if the components of a recommended system may be purchased online. For example, a manufacturer of a component may prohibit a dealer from selling directly over the Internet but the dealer may be allowed to advertise price and availability of the component. In this case, the dealer may not deliver the component from the dealer's inventory to an online customer. Shipping rules 2055 are also consulted 2045 to determine if it is possible to ship a component. For example, some components may be too large to ship directly to a customer and can only be picked up at a storefront. In this case, a component may not be purchased online. If it is determined 2020 that the component may be sold online, the component is reserved 2060 within previously described virtual database 440. A reservation within the virtual database ensures that the component is reserved regardless of the source of the component. If a component may not be sold online and shipped directly to a customer, the component may still be sold online and the customer picks up the component from a dealer. In this case a deposit is taken for the component and the dealer collects the rest of the purchase price. If it is determined 2040 that a deposit can be taken for the component, a deposit is taken 2050 and the component is reserved 2060 in the virtual database as previously described. If no online purchases may be made and no deposits can be taken, the component is still reserved 2060 in the virtual database as previously described.

Although a preferred embodiment of the present invention has been described, it should not be construed to limit the scope of the appended claims. Those skilled in the art will understand that various modifications may be made to the described embodiment. For example, any communications network which is capable of supporting client-server architecture may be used to implement the invention whereas the disclosed embodiments use HTTP on top of a common TCP/IP network.

Moreover, to those skilled in the various arts, the invention itself herein will suggest solutions to other tasks and adaptations for other applications. For example, many different markets may be supported by a merchandising portal as described in the present invention and not just the consumer electronics market. Any market where a customer expects personalized support from a dealer may be implemented by the present invention.

It is therefore desired that the present embodiments be considered in all respects as illustrative and not restrictive, reference being made to the appended claims rather than the foregoing description to indicate the scope of the invention.

1. A method of selecting a recommended system composed of at least one product, comprising:
accepting a plurality of system cases comprising a plurality of product identifiers;
accepting a desired system comprising a plurality of attributes;
creating a plurality of system indexes by calculating a system index for each pairing of each of the plurality of system cases with the desired system; and
selecting a system case as the recommended system by comparing the plurality of system indexes.

2. The method of claim 1 further comprising:
associating the desired system with a physical location; and
determining a subset of system cases for comparison based on the desired system physical location.

3. The method of claim 1 wherein:
the calculation of the system index includes,
transforming the desired system into a desired system column matrix of attribute values,
transforming the system case into a system case column matrix of attribute values,
subtracting the desired system column matrix from the system case column matrix to create a difference column matrix,
creating a system index by multiplying the difference column matrix by a weight row matrix; and
the comparison of system indexes includes selecting the system case whose system index has the lowest absolute value.

4. The method of claim 3, further comprising selection of a weight row matrix element based on the numeric sign of the corresponding element in the difference column matrix.

5. The method of claim 3, further comprising:
associating the desired system with a physical location; and
determining a subset of system cases for comparison based on the desired system physical location.

6. The method of claim 4, further comprising:
associating the desired system with a physical location; and
determining a subset of system cases for comparison based on the desired system physical location.

7. A method of creating a specific targeted offer for a customer comprising:
creating a superset of marketing rules by accepting one subset of marketing rules from each of a plurality of marketeers;
collecting customer data about the customer; and
generating a specific targeted offer using the superset of marketing rules and the customer data.

8. The method of claim 7 wherein the plurality of marketeers comprises at least one supplier, at least one portal merchandiser, and at least one dealer.

9. The method of claim 8 further comprising:
associating a physical location with the customer; and
choosing a dealer rule subset based on the physical location associated with the customer.

10. The method of claim 9 wherein:
the customer data includes,
a history of demonstrations made to the customer,
a history of the product descriptions viewed by the customer,
a physical location associated with the customer, and
a list of products selected by the customer for possible purchase.

11. The method of claim 10 wherein the plurality of marketeers comprises at least one supplier, at least one portal merchandiser, and at least one dealer.

12. The method of claim 11 further comprising choosing a dealer rule subset based on the physical location associated with the customer.

13. A method for creating a virtual inventory database from a plurality of inventory databases, comprising:
accepting inventory data from a plurality of inventory databases;
creating a superset of virtual inventory database creation rules by accepting one subset of virtual inventory database creation rules from each of a plurality of marketeers;
collecting customer data about a customer; and
generating a virtual inventory database using the superset of virtual inventory database creation rules and the customer data.

14. The method of claim 13 wherein the plurality of inventory databases includes at least one dealer inventory database, at least one supplier inventory database, and at least one distributor inventory database.

15. The method of claim 14 further comprising:
associating a physical location with the customer; and
choosing at least one dealer inventory database and at least one dealer virtual database creation rule subset based on the physical location associated with the customer.

16. A data processing system adapted to select a recommended system composed of at least one product, comprising:
a processor; and
a memory operably coupled to the processor and having program instructions stored therein, the processor being operable to execute the program instructions, the program instructions including:
storing a plurality of system cases including a plurality of product identifiers;
accepting a desired system including a plurality of attributes;
determining a subset of the plurality of stored system cases;
creating a plurality of system indexes by calculating a system index for each pairing of a member of the subset of system cases and the desired system; and
selecting a system case as the recommended system by comparing the plurality of system indexes.

17. The data processing system of claim 16, the program instructions further including:
associating a physical location with the desired system; and
selecting system cases based on the physical location associated with the desired system

18. The data processing system of claim 16, the program instructions further including:
transforming the desired system into a desired system column matrix of attribute values;
transforming the system case into a system case column matrix of attribute values;
subtracting the desired system column matrix from the system case column matrix to create a difference column matrix;
creating a system index by multiplying the difference column matrix by a weight row matrix; and
selecting the system case whose system index has the lowest absolute value.

19. The data processing system of claim 18, the program instructions further including selection of a weight row matrix element based on the numeric sign of the corresponding element in the difference column matrix.

20. The data processing system of claim 18, the program instructions further including:
associating a physical location with the desired system; and
determining the subset of system cases by selecting system cases based on the physical location associated with the desired system.

21. The data processing system of claim 19, the program instructions further including:
associating a physical location with the desired system; and
determining the subset of system cases by selecting system cases based on the physical location associated with the desired system.

22. A data processing system adapted to create a specific targeted offer for a customer, comprising:
a processor; and
a memory operably coupled to the processor and having program instructions stored therein, the processor being operable to execute the program instructions, the program instructions including:
creating a superset of marketing rules by accepting one subset of marketing rules from each of a plurality of marketeers;
collecting customer data about the customer; and
generating the specific targeted offer using the superset of marketing rules and the customer data.

23. The data processing system of claim 22, wherein the plurality of marketeers comprises at least one supplier, at least one portal merchandiser, and at least one dealer.

24. The data processing system of claim 22, the program instructions further including:
associating a physical location with the customer; and
choosing a dealer rule subset based on the physical location associated with the customer.

25. The data processing system of claim 22, wherein the customer data comprises:
a history of demonstrations made to the customer;
a history of the product descriptions viewed by the customer;
a physical location associated with the customer; and
a list of products selected by the customer for possible purchase.

26. The data processing system of claim 25 wherein the plurality of marketeers includes at least one supplier, at least one portal merchandiser, and at least one dealer.

27. The data processing system of claim 26 further comprising means for choosing the dealer rule subset based on the physical location associated with the customer.

28. A data processing system adapted to create a virtual inventory database from a plurality of inventory databases, comprising:
a processor; and
a memory operably coupled to the processor and having program instructions stored therein, the processor being operable to execute the program instructions, the program instructions including:
accepting inventory data from a plurality of inventory databases;
creating a superset of virtual inventory database creation rules by accepting a subset of virtual inventory database creation rules from each of a plurality of marketeers;
collecting customer data about a customer; and
generating a virtual inventory database using the superset of virtual inventory database creation rules and the customer data.

29. The data processing system of claim 28 wherein the plurality of inventory databases includes at least one dealer inventory database, at least one supplier inventory database, and at least one distributor inventory database.

30. The data processing system of claim 29, the program instructions further including:
associating a physical location with the customer; and
choosing at least one dealer inventory database and at least one dealer virtual database creation rule subset based on the physical location associated with the customer.

31. A computer-readable storage medium embodying computer program instructions for execution by a computer, the computer program instructions adapting a computer to select a recommended system composed of at least one product, the computer program instructions comprising:
storing a plurality of system cases including a plurality of product identifiers;
accepting a desired system including a plurality of attributes;
determining a subset of the plurality of stored system cases;
creating a plurality of system indexes by calculating a system index for each pairing of a member of the subset of system cases and the desired system; and selecting a system case as the recommended system by comparing the plurality of system indexes.

32. The computer-readable storage medium of claim 31, the computer program instructions further including:
associating a physical location with the desired system; and
selecting system cases based on the physical location associated with the desired system

33. The computer-readable storage medium of claim 31, the computer program instructions further including:
transforming the desired system into a desired system column matrix of attribute values;
transforming the system case into a system case column matrix of attribute values;
subtracting the desired system column matrix from the system case column matrix to create a difference column matrix;
creating a system index by multiplying the difference column matrix by a weight row matrix; and
selecting the system case whose system index has the lowest absolute value.

34. The computer-readable storage medium of claim 33, the computer program instructions further including selection of a weight row matrix element based on the numeric sign of the corresponding element in the difference column matrix.

35. The computer-readable storage medium of claim 33, the computer program instructions further including:
associating a physical location with the desired system; and
determining the subset of system cases by selecting system cases based on the physical location associated with the desired system.

36. The computer-readable storage medium of claim 34, the computer program instructions further including:
associating a physical location with the desired system; and
determining the subset of system cases by selecting system cases based on the physical location associated with the desired system.

37. A computer-readable storage medium embodying computer program instructions for execution by a computer, the computer program instructions to create a specific targeted offer for a customer, the computer program instructions comprising:
creating a superset of marketing rules by accepting one subset of marketing rules from each of a plurality of marketeers;
collecting customer data about the customer; and
generating the specific targeted offer using the superset of marketing rules and the customer data.

38. The computer-readable storage medium of claim 37, wherein the plurality of marketeers comprises at least one supplier, at least one portal merchandiser, and at least one dealer.

39. The computer-readable storage medium of claim 37, the computer program instructions further including:
associating a physical location with the customer; and
choosing a dealer rule subset based on the physical location associated with the customer.

40. The computer-readable storage medium of claim 37, wherein the customer data comprises:
a history of demonstrations made to the customer;
a history of the product descriptions viewed by the customer;
a physical location associated with the customer; and
a list of products selected by the customer for possible purchase.

41. The computer-readable storage medium of claim 40 wherein the plurality of marketeers includes at least one supplier, at least one portal merchandiser, and at least one dealer.

42. The computer-readable storage medium of claim 41, the computer program instructions further comprising choosing the dealer rule subset based on the physical location associated with the customer.

43. A computer-readable storage medium embodying computer program instructions for execution by a computer, the computer program instructions adapting a computer to create a virtual inventory database from a plurality of inventory databases, the computer program instructions comprising:
accepting inventory data from a plurality of inventory databases;
creating a superset of virtual inventory database creation rules by accepting a subset of virtual
inventory database creation rules from each of a plurality of marketeers;
collecting customer data about a customer; and
generating a virtual inventory database using the superset of virtual inventory database creation rules and the customer data.

44. The computer-readable storage medium of claim 43, wherein the plurality of inventory databases includes at least one dealer inventory database, at least one supplier inventory database, and at least one distributor inventory database.

45. The computer-readable storage medium of claim 44, the computer program instructions further including:
associating a physical location with the customer; and
choosing at least one dealer inventory database and at least one dealer virtual database creation rule subset based on the physical location associated with the customer.
